(19) United States
(12) Patent Application Publication
(10) Pub. No.: US 2023/0124418 A1
(43) Pub. Date: Apr. 20, 2023

(54) MEASURING TAPE FOR ELEVATOR INSTALLATIONS

(71) Applicants: Felix Grimm, Rielasingen (DE); Moritz Grimm, Gailingen (DE)

(72) Inventor: Stephan Rohr, Triesen (LI)

(73) Assignees: Felix Grimm, Rielasingen (DE); Moritz Grimm, Gailingen (DE)

(21) Appl. No.: 17/908,685

(22) PCT Filed: Mar. 4, 2020
(86) PCT No.: PCT/EP2020/055746

§ 371 Date: Sep. 1, 2022

(51) Int. Cl. B66B 1/34; G01B 7/04

(52) U.S. Cl. CPC B66B 1/3492; G01B 7/046

(57) ABSTRACT

A measuring tape (10) for determining the position of an elevator car (42) in an elevator shaft (41), the measuring tape being vertically disposable in the elevator shaft and preferably being disposable so as to extend across at least two building floors, the measuring tape having a tape-shaped base body (11) and a position coding which is capable of being read out by means of a magnetic field sensor and is made of ferromagnetic material, the tape-shaped base body (11) is made of textile material and the position coding is disposed so as to be inserted into the base body or so as to be applied to a surface of the base body (11).

### BACKGROUND OF THE INVENTION

The present invention relates to a measuring tape and/or a measuring transducer for determining the position of an elevator car in an elevator shaft and to a measuring system comprising a measuring tape.

Devices for the position detection of an elevator car of an elevator installation are known from the state of the art. Said devices serve to provide information about the current position of the elevator car along the elevator shaft and/or the associated elevator rails in the shaft. In addition to simple position encoders, as for example shaft switches, which give feedback about a current elevator car position at predefined positions in the elevator shaft, also exist incremental position encoders which enable an exact position determination at every position in the shaft.

EP 3 231 753 teaches for example an elevator installation having a measuring tape disposed in the elevator shaft for the position determination of the elevator car in the elevator shaft. The measuring tape has an optical coding in the form of position patterns which follow one after the other, in particular 2D codes, for the length measurement. A sensor element is fixed to the elevator car, said sensor element comprising a light source and a sensor and comprising a detection field for detecting the measuring tape and evaluating a corresponding elevator car position.

Such a measuring tape is usually realized as a steel tape on which the optical code is imprinted and enclosed with a plastic layer.

The company Fritz Kibler GmbH sells a system for the position detection of an elevator car in an elevator shaft, in said system a perforated steel tape being scanned by means of an optical sensor disposed at the elevator car. The steel tape has a position coding in the form of bore holes and/or oblong holes which is scanned contactlessly by means of a photoelectric barrier.

However, such optical systems have the disadvantage of an increased susceptibility to failure if dirt enters the mechanics of the elevator system. Systems which are based on magnetic influence or on induced alternating fields and in which a coding is inserted into a steel tape or coupled into a steel tape in such a manner that it can be magnetically influenced are also known.

DE 10 2004 043 099 A1 discloses, for example, a device for the position detection of an elevator car, electromagnetic alternating fields which are influenced by means of a magnet disposed at the elevator car being inserted into a rope which is tensioned parallel to the elevator rails and which is electrically conductive. An evaluation unit which is not disposed at the elevator car detects the elevator car position by recording a deflection caused by the magnet at the elevator car.

EP 0 927 674 A1 discloses a reading head fixed to the elevator car or the vehicle in order to evaluate a magnetically encoded tape tensioned along a rail, the reading head having magnetically sensitive sensors for the position determination by means of the coding in the tape.

A problem with the known devices and system is maintaining a defined arrangement of the tape in the elevator shaft while maintaining a reliable position detection, in particular in newly constructed buildings which only settle after some time, i.e. which experience a compression strain due to material loads, changes in the building fabric etc., which can cause, in particular, an arching and/or bending and, in the worst case, damage to the tape. This can be addressed by a manual readjustment or by a tensioning and/or storage device for the tape in the elevator shaft which is to be additionally provided. However, the latter can entail significant additional costs and increase the susceptibility of the device and/or the system to failure

### SUMMARY OF THE INVENTION

The object of the invention is to provide an improved measuring transducer, in particular a measuring tape, and an associated measuring system which overcomes or at least significantly reduces the above-mentioned disadvantages of the state of the art. In addition to a reliable detection of an elevator car position in the elevator shaft, an easy and inexpensive producibility and preferably a simplified mountability in the elevator shaft is to be enabled. This object is attained by the subject matter of the independent claims. The dependent claims describe advantageous embodiments of the present invention. Furthermore, the invention addresses further problems which are explained in the following description.

In a first aspect, the invention relates to measuring tape for determining the position of an elevator car in an elevator shaft, said measuring tape being vertically disposable in the elevator shaft and preferably being disposable so as to extend across at least two building floors, said measuring tape having a tape-shaped base body and a position coding which is capable of being read out by means of a magnetic field sensor and is made of ferromagnetic material, wherein the tape-shaped base body is made of textile material and wherein the position coding is disposed so as to be inserted into the base body or so as to be applied to a surface of the base body.

In contrast to the known state of the art, the measuring tape is now not itself made of a ferromagnetic tape, such as iron, but consists of a textile base body into which the position coding is inserted or to which it is applied. Thereby, a lighter total weight of the tape is achieved and it is usable in an extended manner. In particular, the measuring tape can also be used in rough environmental conditions, such as under the influence of salt water, as for example for the position determination on ships, wind turbines, shipyards etc. Furthermore, the textile base body has a greater tape elongation and flexibility than the known steel measuring tapes, which simplifies the installation and positioning in an elevator shaft. Moreover, the measuring tape according to the invention also enables an easier and faster manufacture. In particular, in contrast to the state of the art, a complex bonding of a steel tape and a rubber compound and a subsequent magnetization is no longer necessary.

In a preferred embodiment, the position coding is realized in such a manner that it produces a magnetic field which is temporary and capable of being read out by means of the magnetic field sensor when being externally excited by means of one or several permanent magnet(s). In this case, the ferromagnetic material is preferably not magnetized, i.e. no permanent magnets or poles are inserted or realized in the position coding. Compared to permanently magnetized measuring tapes of the state of the art, this has the advantage that the measuring tape does not adhere to magnetically conductive objects in the elevator shaft and that it is, furthermore, insensitive to a possible demagnetization by other strong permanent magnets, in particular floor magnets provided in the elevator shaft. This also extends the arrangement options in the elevator shaft.

Alternatively, the position coding can also have magnetized poles which are inserted into the ferromagnetic material. Thereby, a position coding with a permanent magnetization can be realized along the measuring tape. This can, for example, be realized by means of magnetized threads or wires which are woven into the textile material at the corresponding position.

The position coding can have any ferromagnetic material. Preferably, the ferromagnetic material consists of steel or iron, in particular in the form of a corresponding wire or thread, for example of steel wire. Said steel wire has preferably a diameter of 0.5 to 2 mm, more preferably of 0.7 to 1 mm.

The tape-shaped base body is preferably woven or knitted from textile material, in particular textile fiber. Alternatively, the base body can also be spun or embroidered.

In a preferred embodiment, the tape-shaped base body has a preferably homogeneous width of 8 to 20 mm, more preferably of 8 to 14 mm, perpendicular to the longitudinal dimension direction. The length of the tape-shaped base body is adapted to the respective elevator shaft in which it is to be disposed. For example, for a five-storied building, it can have a length of about 15 m.

The base body is preferably realized as a continuous body. This means that the base body has in particular no cutouts, holes, oblong holes or other clearances. In other words, the base body is preferably realized as an essentially homogeneous tape-shaped body. In this case, the textile design of the base body is preferably homogeneous across the entire longitudinal direction. For example, in a woven base body, the elongated warp threads extend preferably across the entire length of the measuring tape. Thereby, in particular compared to steel tapes which have punched and perforated clearances and/or oblong holes and are known from the state of the art, homogeneous material properties are achieved across the entire measuring tape length and, in particular, an improved homogeneous strength of the measuring tape is achieved.

In a preferred embodiment, the ferromagnetic material of the position coding is inserted into, in particular woven into, the base body. In this case, the ferromagnetic material has preferably a plurality of warp threads running longitudinally to the direction in which the base body extends and/or weft threads running transversely to the direction in which the base body extends, preferably made of steel wire.

In an alternative embodiment, the ferromagnetic material of the position coding is applied to, in particular imprinted on, a surface of the base body. In this case, the ferromagnetic material comprises preferably ferrite powder which is imprinted on the surface of the textile base body.

The position coding has preferably a plurality of areas which are disposed in the longitudinal direction of the base body so as to follow one after the other and are magnetically distinguishable by means of a magnetic sensor. The magnetically distinguishable areas are preferably realized for the respective interaction with permanent magnets which are of different polarity and which are preferably disposed laterally to the measuring tape. The magnetically distinguishable areas comprise preferably at least one first area which can interact with a first permanent magnet (e.g. north pole) assigned to the measuring tape to produce a first magnetic field and at least one second area which can interact with a second permanent magnet (e.g. south pole) assigned to the measuring tape and having a different pole to produce a second magnetic field which can be distinguished from the first magnetic field. The magnetically distinguishable areas can alternatively also be realized by a permanent magnetization of the ferromagnetic material, in particular as south pole or north pole.

The magnetically distinguishable areas can be disposed in an alternating manner in the longitudinal dimension direction of the tape. Thereby, in particular an incremental position coding can be provided. The magnetically distinguishable areas can also be disposed sequentially or in an absolutely encoded manner in the longitudinal dimension. In this case, the 7espectivee areas can be present in a predefined arrangement or order in the longitudinal dimension direction. In this case, in particular the respective dimensional length in the longitudinal direction and/or the respective type of area, i.e. suitable to produce a first or a second magnetic field, can vary in the longitudinal direction of the measuring tape or be realized irregularly.

The magnetically distinguishable areas each preferably are realized by a preferably homogeneous meandering design or arrangement of a ferromagnetic material. In particular, the magnetically distinguishable areas can be made of a steel wire having an essentially homogeneous diameter and being inserted in, preferably woven in or knitted in, the textile material.

Each magnetically distinguishable area preferably has a homogeneous dimension in the longitudinal dimension direction of the measuring tape. The respective dimension in the longitudinal dimension direction is preferably between 5 and 15 mm, more preferably between 7 and 12 mm.

The respective magnetically distinguishable areas are preferably assigned to a respective longitudinal side of the measuring tape for the respective interaction with permanent magnets which can be disposed laterally to the measuring tape. This means that the respective areas do not extend across the complete width of the measuring tape, but that each area is closer to one of the two longitudinal sides of the measuring tape. In a top view onto the measuring tape, the respective different areas are, thus, preferably disposed so as to follow one after the other and so as to be laterally offset with respect to each other in the longitudinal direction of the measuring tape.

In a preferred embodiment, the measuring tape has insulating means which are made of a material which is not magnetically conductive, in particular plastic material, and which extend transversely to the running direction or the longitudinal dimension direction of the measuring tape and are disposed between the individual magnetic areas and/or extend parallel to a lateral edge of the measuring tape. Due to these insulating means, a respective magnetic field can be produced temporarily in an optimized manner under the interaction of the respective area with a respective permanent magnet provided to interact with the area.

The insulating means can, for example, be made of plastic threads which are incorporated into, in particular woven into or knitted into, the textile material. Alternatively, the insulating means can be glued onto a surface of the base body. The insulating means have preferably a diameter of 0.5 to 2 mm, more preferably of 0.8 to 1.5 mm.

The measuring tape can have function and/or signal lines which are incorporated into, in particular woven into or knitted into, the base body in the longitudinal direction and which are preferably realized in a non-force-absorbing manner. Said function and/or signal lines can serve to transmit signals along the measuring tape and can be contacted at provided contact positions by means of external components to transmit signals.

The measuring tape can have a cover layer which is applied to the base body and covers the position coding. Said cover layer is in particular made of woven or knitted textile material. Alternatively, the cover layer can be made of another material, for example of plastic.

The measuring tape can have reflectors which are inserted into, in particular woven into or knitted into, the textile material of the base body. Said reflectors can, for example, due to a suitable arrangement, provide information which can be read out, for example, by means of an optical sensor.

In another aspect, the invention relates to a measuring system, comprising a measuring tape as described above and comprising a sensor arrangement having at least one magnetic field sensor for reading out the position coding of the measuring tape. In an especially preferred embodiment, the sensor arrangement of the system has at least one permanent magnet for a temporary magnetization of the ferromagnetic material of the position coding of the measuring tape, wherein the at least one magnetic field sensor is realized for reading out the temporary magnetic field generated in this process.

In this case, the sensor arrangement is provided at an elevator car of an elevator system for a positionally fixed arrangement. In this case, the elevator car having the sensor arrangement fixed thereto travels along the measuring tape in the elevator shaft, the interaction of the measuring tape and the assigned sensor arrangement enabling a position determination of the elevator car in the elevator shaft.

The sensor arrangement is preferably configured to pass on the position, speed and/or acceleration of an assigned elevator car to a higher-level control by reading out the measuring tape. This is preferably realized by reading out and/or scanning the permanently present or temporarily generated magnetic fields of the measuring tape and/or the field jumps occurring between the respective magnetic fields when the sensor arrangement moves along the measuring tape. For this purpose, the sensor arrangement and/or the control can have a correspondingly configured microcontroller.

In a preferred embodiment, the measuring system has at least one guide rail which is assigned to the measuring tape and which has permanent magnets of different polarity disposed laterally to the measuring tape. The guide rail can have a preferably groove-shaped cavity to receive and to guide the measuring tape and guide cheeks running laterally thereon in which preferably the permanent magnets are disposed. The guide rail is preferably disposed in such a manner that the magnets of different polarity extend along opposite sides in the longitudinal direction of the measuring tape. The permanent magnets have preferably a longitudinal dimension across a length of 30 to 600 mm, more preferably of 40 to 550 mm.

The magnetic field sensor of the measuring system has at least one Hall sensor, preferably a majority of Hall sensors which are disposed in a row and which are disposed parallel to the running direction of the measuring tape. The magnetic field sensor is preferably disposed parallel to a surface of the measuring tape. The magnetic field sensor is preferably disposed so as to be opposite to a groove base of the cavity of the guide rail in such a manner that the measuring tape is disposed or runs, in particular in a sandwich-like manner, between the guide rail and the magnetic field sensor.

In a preferred embodiment, the sensor arrangement has a flux amplifier which is designed for the concentration of a magnetic field delivered by the measuring tape. The flux amplifier preferably has a metallic element, such as a steel sheet, which is disposed parallel to the running direction of the measuring tape and which has preferably a homogeneous cross section. The flux amplifier is preferably disposed on a side of the magnetic field sensor of the sensor arrangement facing away from the measuring tape. Thus, the magnetic field sensor can be disposed in a sandwich-like manner between the magnetic tape and the flux amplifier.

In another aspect, the invention relates to an elevator system having an elevator shaft and an elevator car movably disposed therein, said elevator system having a measuring system for determining the position of the elevator car in the elevator shaft as described above.

### BRIEF DESCRIPTION OF THE DRAWINGS

Further advantageous details of the invention are apparent from the subsequent description of preferred exemplary embodiments and from the figures.

FIG. 1 shows a schematic side view of a preferred exemplary embodiment of an elevator system according to the invention;

FIG. 2 shows a top view onto a preferred embodiment of the measuring tape according to the invention with an assigned guide rail having permanent magnets;

FIG. 3a shows a perspective side view of the measuring tape in an assigned guide rail;

FIG. 3b shows a perspective side view of a yoke element which can be mounted on the guide rail;

FIG. 4a shows a perspective side view of a sensor arrangement of the measuring system according to the invention;

FIG. 4b shows a perspective bottom view onto a sensor arrangement according to FIG. 4a;

FIG. 4c shows a sectional view of a preferred embodiment of the measuring system according to the invention comprising a measuring tape and an assigned sensor arrangement for reading out the position coding; and

FIGS. 5a, 5b shows lateral views of the magnetic field line course of the position coding of the measuring tape when being scanned by the sensor arrangement.

In the figures, identical elements and elements having the same function are marked with the same reference numerals.

### DETAILED DESCRIPTION

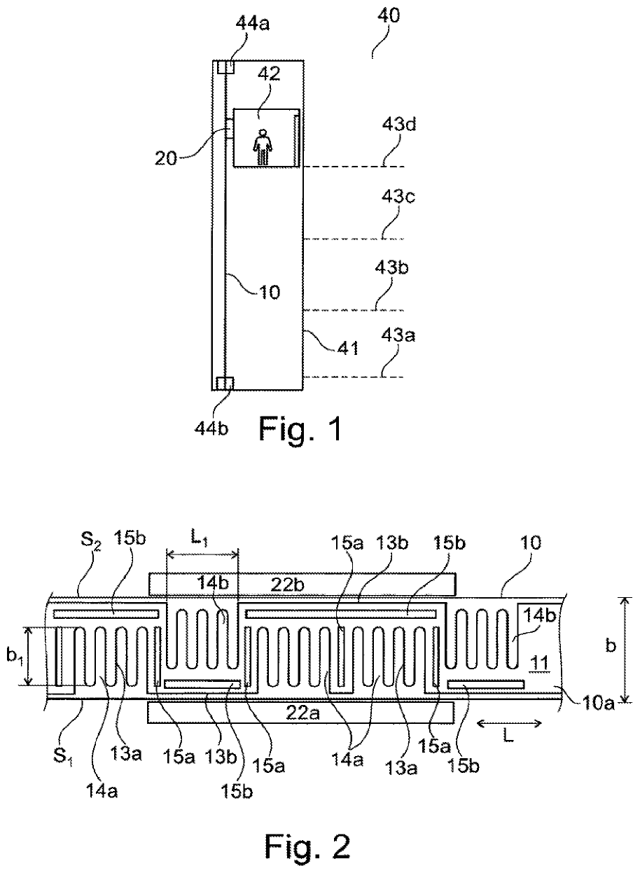

FIG. 1 shows an elevator system 40 having an elevator shaft 41 extending across several floors 43a-d, for example of a building, ship, crane boom or high-bay warehouse, and an elevator car 42 movably disposed therein. Furthermore, the system has drive means (not shown) which are essentially known and which enable a selective movement of elevator car 42 in elevator shaft 41. For the position detection of the elevator car in elevator shaft 41, elevator system 40 has a measuring system 30 according to the invention, said measuring system 30 being described in more detail below and comprising a measuring tape 10 disposed in elevator shaft 41 and a sensor arrangement 20 interacting with said measuring tape 10 and disposed at elevator car 42. Measuring tape 10 extends vertically through entire elevator shaft 41 and is held securely in position in the elevator shaft by means of provided fixing means 44a and 44b.

FIG. 2 shows a schematic top view onto a preferred embodiment of measuring tape 10 according to the invention. Measuring tape 10 comprises a tape-shaped base body 11 made of textile material. Said base body 11 is made into a longitudinally extending tape from a suitable textile yarn consisting of one or several textile fibers, preferably by means of weaving or knitting. In the shown embodiment, the textile tape is a fabric made of a plurality of weft and warp threads. In this case, the warp threads running into the longitudinal direction take up the tape tension. Measuring tape 10 has preferably a homogeneous width b of 8 to 20 mm, more preferably of 8 to 14 mm, perpendicular to longitudinal dimension direction L of measuring tape 10. Length L of measuring tape 10 is adapted to the respective length of elevator shaft 41.

Measuring tape 10 has a position coding 12 made of ferromagnetic material which is capable of being read out by means of a magnetic field sensor 21 of a sensor arrangement 20 which is assignable to tape 10. Position coding 12 is preferably inserted in textile base body 11 of the measuring tape, in particular interwoven or knitted therewith. In this case, the ferromagnetic material is preferably a metal wire, in particular a steel wire, which is incorporated into base body 11. In this case, position coding 12 has a plurality of warp threads 13b running longitudinally to the direction in which the base body extends and weft threads 13a running transversely to the direction in which the base body extends. Said threads form a predefined pattern in base body 11 with which first and second magnetically distinguishable areas 14a and 14b are formed. In the present context, “magnetically distinguishable” is understood to mean that said areas are magnetically distinguishable by means of an assignable magnetic field sensor.

As illustrated, magnetically distinguishable areas 14a and 14b are in particular realized by a respective meandering design or arrangement of the ferromagnetic material in base body 11. In this case, magnetically distinguishable areas 14a and 14b are disposed in longitudinal direction L of base body 11 in a predefined arrangement so as to follow one after the other, each area having a preferably homogeneous dimension L1 in the longitudinal direction. Furthermore, respective areas 14a and 14b have a preferably homogenous width b1 perpendicular to the longitudinal direction of base body 11. This results in a preferably square or rectangular area for respective area 14a and 14b in a top view onto measuring tape 10.

Magnetically distinguishable areas 14a and 14b are preferably realized for the respective interaction with permanent magnets 22a and 22b which are of different polarity and which are disposed laterally to measuring tape 10. In this case, said permanent magnets 22a and 22b extend in longitudinal direction L along a respective side edge S1, S2 of measuring tape 10 across a predefined length. First areas 14a are disposed closer to a side edge S1 of the measuring tape which is assigned to permanent magnet 22a or which runs adjacent to these. Second areas 14b are disposed closer to a side edge S2 of the measuring tape which is assigned to permanent magnet 22b or which runs adjacent to these. When measuring tape 10 passes through the two stationary permanent magnets 22a and 22b, first areas 14a are thus in particular temporarily magnetized by first permanent magnet 22a and second areas 14b are in particular temporarily magnetized by second permanent magnet 22b. In this case, a magnetic field 24a, 24b and 24c (cf. FIGS. 5a and 5b) is produced in each case in the third dimension, i.e. in a direction perpendicular to surface 10a of measuring tape 10 which can be read out by means of an assigned magnetic field sensor 21 (cf. FIGS. 5a and 5b).

Furthermore, measuring tape 10 can have insulating means 15a and 15b which are made of a material which is not magnetically conductive, in particular plastic material, and which extend transversely to running direction L of measuring tape 10 and are disposed between individual magnetic areas 14a and 14b and/or extend parallel to a lateral edge S1, S2 of the measuring tape. Said material which is not magnetically conductive can preferably be inserted into, for example woven into or knitted into, the textile material of base body 11 by means of plastic thread.

Insulating means 15a and 15b optimize the respective interaction of first and second areas 14a and 14b with assigned permanent magnets 22a and 22b respectively. In particular in this case, respective areas 14a and 14b can be shielded from the not assigned permanent magnets 22a and 22b, respectively, i.e. the permanent magnet with which they are not to interact, in particular by means of insulating means 15b extending in the longitudinal direction. By an arrangement of insulating means 15a which are in each case disposed between adjacent areas 14a and 14b and preferably run transversely to the longitudinal direction, an optimized magnetic delimitation of the respective adjacent areas is realized.

Alternatively to the above-described embodiment, magnetically distinguishable areas 14a and 14b can be permanently magnetized, for example by inserting in each case magnetized ferromagnetic material during the production process of measuring tape 10, for example a magnetized steel wire which, in this case, has a different polarity for respective areas 14a and 14b. Alternatively, respective areas 14a and 14b can be correspondingly magnetized after the manufacture of the measuring tape.

Also alternatively to the aforementioned embodiment, the ferromagnetic material can be imprinted on a surface 10a of measuring tape 10 or applied to it in a different way. For example, the ferromagnetic material can be imprinted as ferrite powder for the formation of corresponding first and second areas 14a and 14b. In the same way, insulating means 15a and 15b can be imprinted or glued on surface 10a.

Furthermore, measuring tape 10 can have a layer (not shown) which covers position coding 12 and is preferably made of textile material.

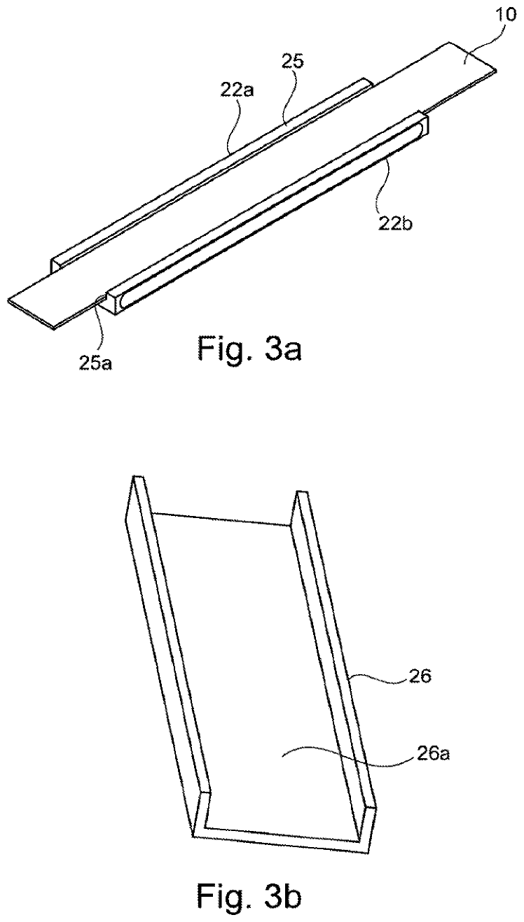

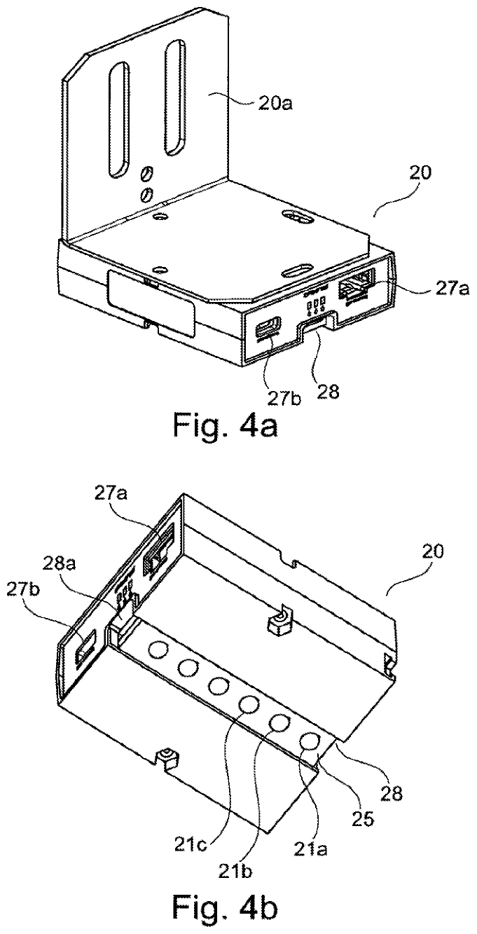

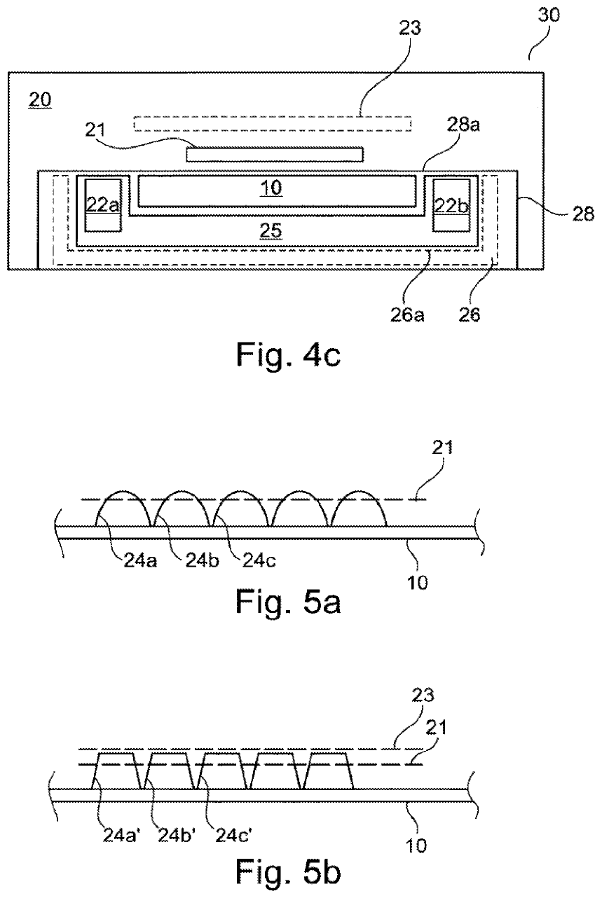

FIG. 3a shows an individual illustration of a guide rail 25 of measuring system 30 (cf. FIG. 4c), said guide rail 25 being assigned to measuring tape 10. Guide rail 25 has an elongated clearance on the long side on the right and left along a guide groove 25a, a bar magnet 22a and 22b of different polarity being placed into each elongated clearance, north on one side and south on the other side of the guide rail. Thus, it is achieved that the respective measuring tape section which is inside guide rail 25 is magnetized as described above. Flux amplifying means (not illustrated) can additionally be provided between respective magnets 22a and 22b and guide groove 25a. Said flux amplifying means can, for example, comprise elongated steel elements running parallel to respective magnets 22a and 22b and guide groove 25a and having an essentially triangular cross section. Thereby, a magnetic flux can be concentrated from the respective magnet toward guide groove 25a.

FIG. 3b shows a yoke element 26 serving to receive guide rail 25. Said yoke element has an elongated recess 26a adapted to the outer dimensions of guide rail 25. Yoke element 26 is made of metal and serves preferably to short-cut the two permanent magnets 22a and 22b of guide rail 25. Thereby, a concentration of the magnetic flux is achieved, which allows an optimized production of the temporary magnetic fields when magnetic tape 10 passes through in guide rail 25.

FIGS. 4a and 4b shows a sensor arrangement 20 for the interaction with measuring tape 10. Sensor arrangement 20 is realized to be disposed at an elevator car 42 of an elevator system 40 so as to be secure in position and, for this purpose, has corresponding positioning means 20a, for example an essentially known mounting device with integrated adjusting means. To integrate sensor arrangement 20 into an elevator control it has connection options 27a and 27b.

Furthermore, sensor arrangement 20 comprises an elongated recess 28 preferably on a bottom of the sensor arrangement, wherein guide rail 25 described above can be received in or inserted into said recess 28. A measuring tape 10 running in guide groove 25a of the guide rail runs between a downward facing surface 28a of recess 28 and guide groove 25a of guide rail 25 and is, thus, disposed in a sandwich-like manner between the aforementioned components. The corresponding distance between surface 28a and guide groove 25a is selected in such a manner that measuring tape 10 can slide in the opening thus generated essentially with no resistance.

Sensor arrangement 20 has at least one magnetic field sensor 21 on surface 28a which is directed toward measuring tape 20. Said magnetic field sensor 21 has preferably a majority of Hall sensors 21a, 21b and 21c which are disposed in a row and which are designed for reading out measuring tape 10 and are disposed parallel to the running direction of the measuring tape.

FIG. 4c shows an associated sectional view of measuring system 30 according to the invention comprising a sensor arrangement 20 and measuring tape 10 placed therein. As shown in the figure, a yoke element 26 surrounding guide rail 25 can be provided as described above to optimize the magnetic flux. Alternatively or additionally, sensor arrangement 20 can have a flux amplifier 23 which is designed or disposed for the concentration of a magnetic field delivered by measuring tape 10. Preferably, flux amplifier 23 comprises a metallic element which has a homogeneous cross section, which extends parallel to running direction L of measuring tape 10 and which is disposed on a side of magnetic field sensor 21 facing away from measuring tape 10.

Due to flux amplifier 23 disposed above and/or on the back of magnetic field sensor 21, compared to the arrangement without a flux amplifier (cf. FIG. 5a), an optimized orientation and/or concentration of the magnetic field 24a′, 24b′ and 24c′ generated in each case by different areas 14a and 14b of measuring tape 10 is achieved in such a manner that the flux flows essentially orthogonally through magnetic field sensor 21 and/or through the respective Hall elements 21a, 21b and 21c and, thus, a stronger magnetic flux with less scattering is produced (cf. FIG. 5b). Thereby, the reading out of the position coding is optimized. In addition, thereby. the distance between measuring tape 10 and magnetic field sensor 21 can be increased, which simplifies the configuration of the system in particular with regard to necessary tolerances.

The above-described embodiments are only examples, the invention being by no means limited to the embodiments shown in the figures.

1. Measuring tape for determining the position of an elevator car (42) in an elevator shaft (41), said measuring tape being vertically disposable in the elevator shaft and being disposable so as to extend across at least two building floors (43, 43b, 43c, 43d), said measuring tape having a tape-shaped base body (11) and a position coding (12) which is capable of being read out by means of a magnetic field sensor and is made of ferromagnetic material, wherein the tape-shaped base body (11) is made of textile material and wherein the position coding (12) is disposed so as to be inserted into the base body or so as to be applied to a surface (11a) of the base body.

2. Measuring tape according to claim 1, wherein the position coding (12) is realized in such a manner that it produces a magnetic field which is temporary and capable of being read out by means of the magnetic field sensor when being externally excited by means of one or several permanent magnet(s).

3. Measuring tape according to claim 1, wherein the tape-shaped base-body (11) is woven or knitted from textile material.

4. Measuring tape according to claim 1, wherein the ferromagnetic material of the position coding (12) is inserted into the base body (11), the ferromagnetic material having a plurality of warp threads (13b) running longitudinally to the direction in which the base body extends and/or weft threads (13a) running transversely to the direction in which the base body extends.

5. Measuring tape according to claim 1, wherein the ferromagnetic material of the position coding (12) is imprinted on a surface (10a) of the base body (10) by means of ferrite powder.

6. Measuring tape according to claim 1, wherein the position coding (12) has a plurality of areas (14a, 14b) which follow one after the other in the longitudinal direction (L) of the base body (10) and are magnetically distinguishable by means of a magnetic sensor, each area having a homogeneous dimension (L1) in the longitudinal direction (L).

7. Measuring tape according to claim 6, wherein the magnetically distinguishable areas (14a, 14b) are realized for the respective interaction with permanent magnets (22a, 22b) which are of different polarity and which are disposed laterally to the measuring tape (10).

8. Measuring tape according to claim 6, wherein the measuring tape (10) has insulating means (15a, 15b) which are made of a material which is not magnetically conductive and which extend transversely to the running direction (L) of the measuring tape and are disposed between the individual magnetic areas (14a, 14b) and/or extend parallel to a lateral edge of the measuring tape.

9. Measuring tape according to claim 6, wherein the magnetically distinguishable areas (14a, 14b) each are realized by a homogeneous meandering design or arrangement of a ferromagnetic material.

10. Measuring tape according to claim 6, wherein the magnetically distinguishable areas (14a, 14b) are disposed in an alternating manner, sequentially or in an absolutely encoded manner in the longitudinal direction (L) of the base body (10).

11. Measuring tape according to claim 1, wherein the base body (10) has function and/or signal lines which are incorporated in the longitudinal direction (L) and which are realized in a non-force-absorbing manner.

12. Measuring tape according to claim 1, wherein the measuring tape (10) has a cover layer which is applied to the base body (11) and covers the position coding (12) and which is made of woven or knitted textile material.

13. Measuring system, comprising a measuring tape (10) according to claim 1 and a sensor arrangement (20) having at least one magnetic field sensor (21) for reading out the position coding (12) of the measuring tape (10).

14. Measuring system according to claim 13, wherein the sensor arrangement (20) has at least one permanent magnet (22) for a temporary magnetization of the ferromagnetic material of the position coding (12) of the measuring tape (10), and wherein the magnetic field sensor (21) is realized for reading out the temporary magnetic field generated in this process.

15. Measuring system according to claim 13, wherein the measuring system has at least one guide rail (25) which is assigned to the measuring tape and which has permanent magnets (22a, 22b) of different polarity disposed laterally to the measuring tape.

16. Measuring system according to claim 13, wherein the magnetic field sensor (21) has a plurality of Hall sensors which are disposed in a row and which are disposed parallel to the running direction (L) of the measuring tape (10).

17. Measuring system according to claim 13, wherein the sensor arrangement (20) has a flux amplifier (23) for the concentration of a magnetic field delivered by the measuring tape (10).

18. Measuring system according to claim 17, wherein the flux amplifier (23) has a metallic element which is disposed parallel to the running direction (L) of the measuring tape (10) and which has a homogeneous cross section.

19. Measuring system according to claim 17, wherein the flux amplifier (23) is disposed on a side of the magnetic field sensor (21) of the sensor arrangement (20) facing away from the measuring tape (10).

20. Elevator system having an elevator shaft (41) and an elevator car (42) movably disposed therein, said elevator system having a measuring system (30) for determining the position of the elevator car (42) in the elevator shaft (41) according to claim 13.
